(19) United States
(12) Patent Application Publication
(10) Pub. No.: US 2009/0101456 A1
(43) Pub. Date: Apr. 23, 2009

(54) DISK THICKNESS VARIATION TOLERANT BRAKE SYSTEM AND METHOD FOR MANUFACTURING THEREOF

(75) Inventor: Charles T. Layton, Beverly Hills, MI (US)

Correspondence Address: DOBRUSIN & THENNISCH PC, 29 W LAWRENCE ST, SUITE 210, PONTIAC, MI, 48342, US

(73) Assignee: AKEBONO CORPORATION (NORTH AMERICA)

(21) Appl. No.: 12/251,841

(22) Filed: Oct. 15, 2008

Related U.S. Application Data
(60) Provisional application No. 60/980,884, filed on Oct. 18, 2007.

(51) Int. Cl. F16D 65/092; F16D 65/04

(52) U.S. Cl. 188/18 A; 188/251 R

(57) ABSTRACT

A corner module, comprising a knuckle, a hub and bearing a caliper assembly including a caliper that carries at least two opposing and spread apart brake pad assemblies, and a rotor having a rotational axis including a hat portion and a disc portion, the disc portion disposed between the at least two brake pads. At least one of the brake pad assemblies and the rotor includes a main body portion having a first stiffness and at least one sacrificial portion having a second stiffness that is less stiff than the first stiffness of the main body portion. In a brake-off position, a first running clearance between the brake pad assembly and the rotor of the at least one sacrificial portion will be lower than a second running clearance between the friction pad and the rotor of the main body portion. In a brake-on position, the axial deflection of the at least one sacrificial portion exceeds the axial deflection of the main body portion.

### CLAIM OF PRIORITY

The present invention claims the benefit of the priority of the filing date of U.S. Provisional Application Ser. No. 60/980,884 filed Oct. 18, 2007, which is herein incorporated by reference for all purpose.

### FIELD OF INVENTION

The present invention is predicated upon systems and methods for improving brake calipers and rotors and more specifically reduction of vibration and noise generated thereby during operation.

### BACKGROUND OF THE INVENTION

Current disc brake systems commonly include a caliper that temporarily clamps opposing friction pads to an annular braking surface on a rotor thereby applying a braking force. As a result of many brake component structures, cyclic contact occurs between the friction pads and the disc portion of the rotor in a “brake-off” position; that is, the position when the operator is not actuating the brake system such as by depressing a brake pedal. In turn, localized rotor wear causes disc thickness variation (DTV). During subsequent braking, this DTV results in cyclic brake torque variation (BTV), which can cause noise and pulsation in the suspension, steering and brake actuation systems. Such pulsation and noise can be a major cause of customer dissatisfaction resulting in warranty costs and loss of future sales. It would be particularly attractive to reduce the undesirable consequences of DTV. U.S. Pat. No. 6,234,284, which is herein incorporated by reference for all purposes, shows one effort to address DTV.

### SUMMARY OF THE INVENTION

The present invention meets the above needs by providing an improved brake system, particularly one adapted for inclusion in an automotive vehicle corner module, and methods of manufacturing the same. By way of summary, the present invention is directed to a brake system, and also to its use in a corner module, e.g., one including a knuckle, a hub and bearing, a caliper assembly including a caliper that carries at least two opposing and spread apart friction pads, and a rotor. In general, the present invention contemplates the employment in a brake system of a rotor having a rotational axis and including a hat portion and a disc portion, with the disc portion disposed between the friction pads. At least one of the friction pads and/or the rotor includes a main body portion having a first stiffness and at least one sacrificial portion having a second stiffness that is less stiff than the first stiffness of the main body portion. In a brake-off position, a first running clearance between the friction pads and the rotor of the sacrificial portion will be lower than a second running clearance between the friction pads and the rotor of the main body portion. In a brake-on position, the axial deflection of the sacrificial portion exceeds the axial deflection of the main body portion.

In another aspect, the present invention contemplates a brake pad for a vehicle that includes a friction pad. The friction pad includes a main body portion having a top surface and a first stiffness, and at least one sacrificial portion having a top surface and a second stiffness that is less stiff than the first stiffness of the main body portion. In a brake-on position, the deflection of the at least one sacrificial portion will be greater than the deflection of the main body portion upon at least a portion of the brake pad engaging at least a portion of a rotor having a rotor axis. In a brake-off position, a first running clearance between the at least one sacrificial portion and the rotor will be lower than a second running clearance between the main body portion and the rotor, and wherein over time, during brake operation, the at least one sacrificial portion will wear at a rate such as to generally maintain a differential height between the top surface of the sacrificial portion and the top surface of the main body portion. The main body portion includes a top surface and a bottom surface that are spaced apart to define a first thickness that is generally parallel to the rotor axis and the at least one sacrificial portion includes a top surface and a bottom surface that are spaced apart to define a second thickness that is generally parallel to the rotor axis and is greater than the first thickness.

In another aspect, the present invention provides a method for manufacturing a brake pad comprising the steps of applying a mass of friction pad material to a pressure plate and separating at least a portion of the friction pad, the pressure plate, or both, thereby at least partially separating a main body portion having a first stiffness from at least one spring blade portion having a second stiffness that is less stiff than the first stiffness.

In yet another aspect, any of the aspects of the present invention may be further characterized by one or any combination of the following features: for the friction pad including the at least one sacrificial portion, the friction pad is supported on a pressure plate that includes a main body portion and at least one spring blade portion that supports the at least one sacrificial portion; the main body portion of the pressure plate, the friction pad, or both includes a top surface and a bottom surface that are spaced apart to define a first thickness, and the at least one spring blade portion, the at least one sacrificial portion, or both includes a top surface and a bottom surface that are spaced apart to define a second thickness such that the top surfaces are at a different height relative to one another in the brake-off position; the second thickness of the at least one sacrificial portion is greater than the first thickness of the main body portion of the friction pad so that the top surface of the at least one sacrificial portion engages the rotor prior to the top surface of the main body portion of the friction pad; the second thickness of the pressure plate is less than the first thickness of the pressure plate, and wherein in the brake-off position, the top surface of the at least one spring blade portion of the pressures plate is generally co-planar relative to the top surface of the main body portion of the pressure plate; the first stiffness and the second stiffness are in the direction generally parallel with the rotational axis of the rotor; the spring blade portion is cantilevered and is joined to the main body portion of the pressure plate via a transition portion about which the spring blade portion deflects when the at least one sacrificial portion engages the rotor; the main body portion and at least one of the at least one sacrificial portion or the at least one spring blade portion form at least one gap therebetween; the main body portion of the friction pad and the at least one sacrificial portion of the friction pad are separate from one another; the ratio of the first stiffness and second stiffness is from about 200,000:1 to about 1,000:1, the at least one sacrificial portion contributes on the order of about 5 to about 15% of the total braking pad surface width, or a combination of both; the caliper further includes a piston portion and a finger portion spaced apart and generally opposing one another, the piston portion or the finger portion located generally adjacent to the bottom surface of the main body portion of the pressure plate and substantially free of contact with the at least one spring blade portion; the main body portion and the at least one sacrificial portion are located within the disc portion of the rotor, the main body portion and the at least one sacrificial portion include a top surface and a bottom surface, and an outer surface and an inner surface and wherein at least one of the top surface or the bottom surface of the main body portion, the at least one sacrificial portion, or both is configured to engage at least one of the at least two friction pads; the main body portion and the sacrificial portion are spaced apart with respect to one another so that the outer surface of one is located proximate to the inner surface of the other and wherein at least one of the top surface or the bottom surface of the sacrificial portion is axially deflected with respect to the top surface or the bottom surface of the main body portion; the at least one sacrificial portion is supported by a plurality of fastening members and wherein a portion of the axial deflection occurs between at least two of the plurality of fastening members; for the friction pad including the at least one sacrificial portion, the friction pad is supported on a pressure plate that includes a main body portion having a first thickness and at least one spring blade portion that supports the at least one sacrificial portion, and wherein the spring blade portion of the pressure plate is coined to thin the spring blade portion and thereby define a second thickness for the spring blade portion that is less than the first thickness of the main body portion of the pressure plate so that a bottom surface of the at least one spring blade portion is axially displaced with respect to a bottom surface of the main body portion; further including the step of removing material from the main body portion of the friction pad so as to defines a first thickness that is less than the at least one sacrificial portion of the friction pad having a second thickness; the step of removing material from the friction pad is achieved by engaging the surface of the friction pad with a material removal tool, during which, because of the deflection of the spring blade portion, the resulting amount of material removed from the at least one sacrificial portion is less than in the main body portion of the friction pad so that a height differential results between the upper surface of the friction pad in the main body portion and the at least one sacrificial portion; further including the step of coining the spring blade portion to thin the spring blade portion and thereby define a second thickness for the spring blade portion that is less than the first thickness of the main body portion so that the bottom surface of the at least one spring blade portion is axially displaced with respect to the bottom surface of the main body portion and further to reduce a portion of the gap between the main body portion and the at least one spring blade portion; or any combination thereof.

### BRIEF DESCRIPTION OF THE INVENTION

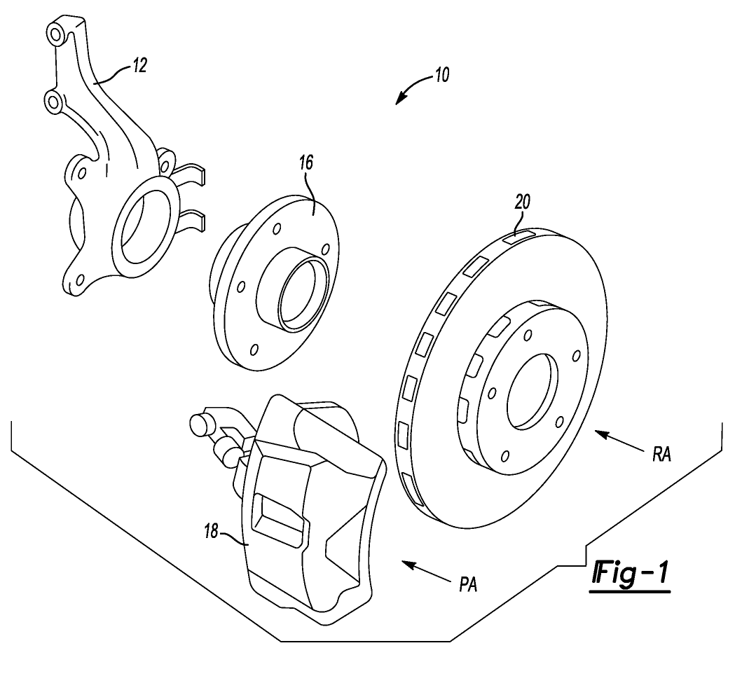

FIG. 1 is an exploded view of an illustrative corner module.

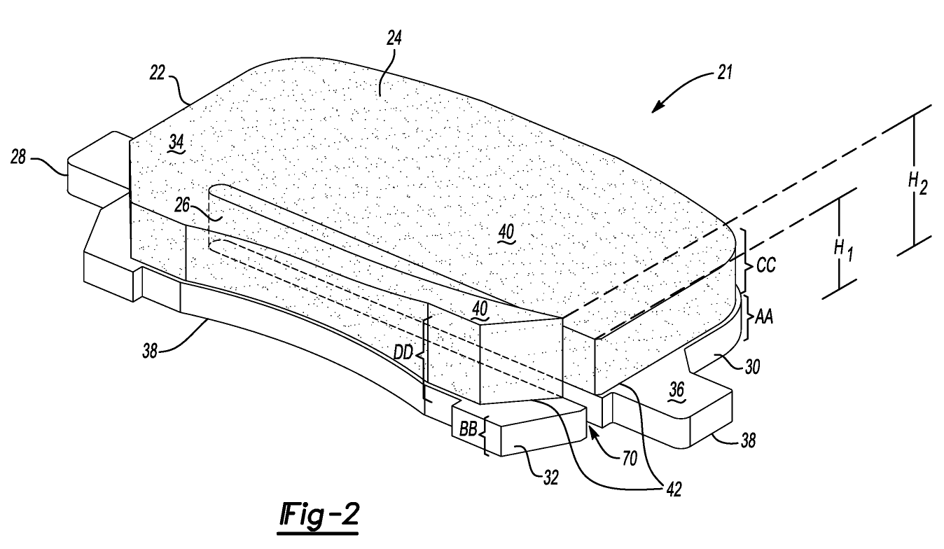

FIG. 2 is a perspective view of one embodiment of a friction pad assembly.

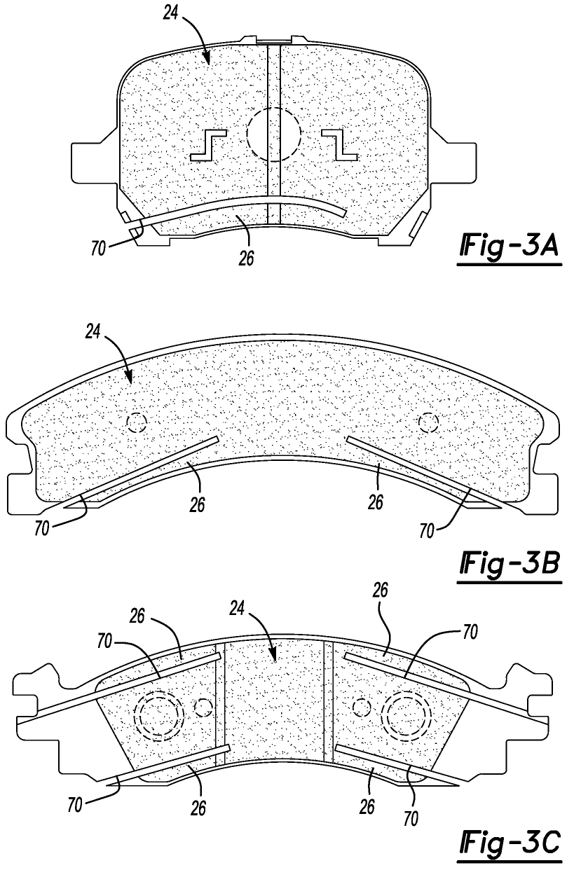

FIG. 3A is an elevational view of another friction pad assembly.

FIG. 3B is an elevational view of another friction pad assembly.

FIG. 3C is an elevational view of another friction pad assembly.

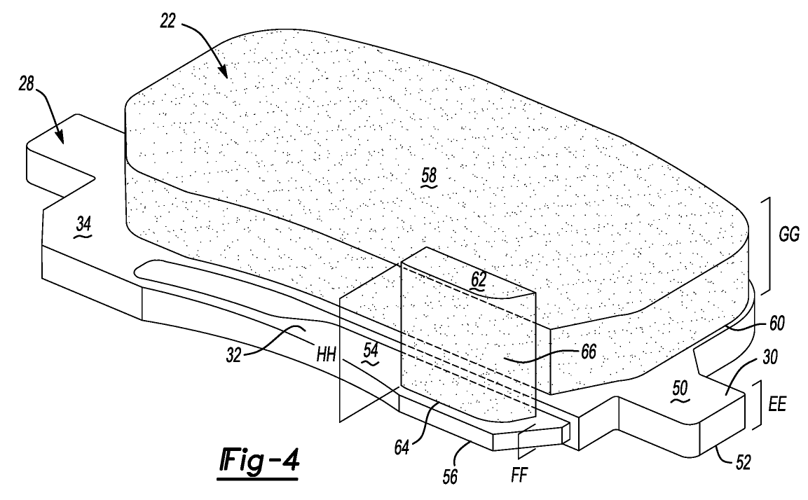

FIG. 4 is a perspective view of another friction pad assembly.

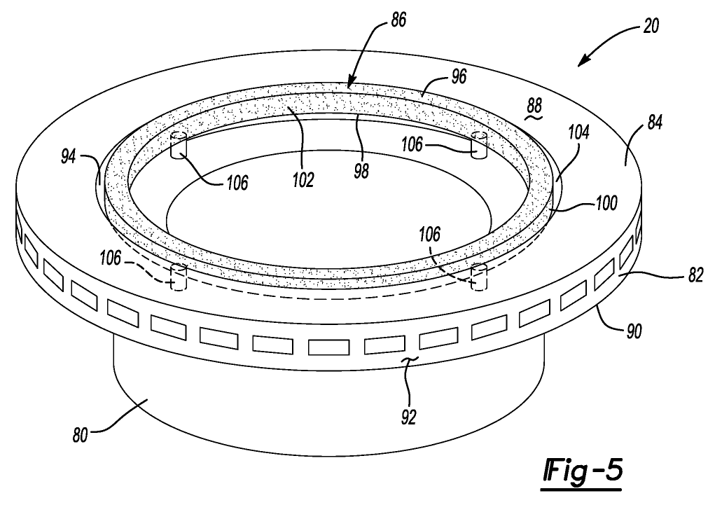

FIG. 5 is a perspective view of one embodiment of a rotor assembly of the present invention.

### DETAILED DESCRIPTION OF THE INVENTION

In a broad sense, the present invention is directed to an improved brake system for overcoming problems associated with disc thickness variation (DTV). In one aspect, the present invention is directed to an improved corner module for an automotive vehicle incorporating the improved brake system. Though fewer or more components may be included in a corner module, it is generally contemplated that a corner module 10 herein will include a steering knuckle 12, a hub 14 and bearing 16, a caliper assembly 18, and a rotor 20. The caliper assembly typically will include at least two opposing and spaced apart brake pads 21, each including a friction pad 22, arranged for clamping engagement with the rotor. The rotor has a rotational axis (shown as RA in FIG. 1), and includes a hat portion 80 and a disc portion 82 that is disposed between the brake pads. At least one of the friction pad and the rotor includes a main body portion having, in the rotor axial direction, a first stiffness and a sacrificial portion having a second stiffness that is less stiff than the first stiffness of the main body portion. Preferably the ratio of the first and second stiffnesses is from about 200,000:1 to about 1,000:1, more specifically about 150,000:1 to about 3500:1.

In a brake-off position, a first running clearance between the friction pad and the rotor of the sacrificial portion will be lower than a second running clearance between the friction pad and the rotor of the main body portion. In a brake-on position, (i.e., a position in which the brakes are actuated by a vehicle operator), the deflection of the sacrificial portion exceeds the deflection of the main body portion; the deflection being in a direction generally parallel with the rotational axis of the rotor, and thus is referred to as “axial deflection.”

The caliper assembly typically includes at least two opposing and spaced apart friction pads 22. At least one friction pad 22 includes a main body portion 24 having a first stiffness and at least one sacrificial portion 26 having a second stiffness that is less stiff than the first stiffness of the main body portion. Such friction pad is typically supported by a pressure plate 28 that includes a main body portion 30 and at least one spring blade portion 32, which supports the sacrificial portion. It is contemplated that the spring blade portion may be part of the pressure plate or an additional component.

The spring blade portion may be cantilevered relative to the main body portion. For instance, the spring blade portion 32 may be joined to the main body portion 30 via a transition region 34 about which the spring blade portion deflects when the sacrificial portion engages the rotor. The pressure plate includes a top surface 36 and a bottom surface 38 and the friction member includes a top surface 40 and a bottom surface 42. The bottom surface 42 of the main body portion 24 of the friction pad may be mounted to the top surface 36 of the main body portion 30 of the pressure plate and the bottom surface 42 of the sacrificial portion 26 may be mounted to the top surface 36 of the spring blade portion 32. The top surface 40 of the friction pad is configured for engaging the rotor.

The caliper assembly further includes a piston portion 72 and a finger portion 74 spaced apart and generally opposing one another. Either or both of the piston portion and the finger portion are located generally adjacent to the bottom surface 38 of the main body portion 30 of the pressure plate.

As shown in FIG. 2, the main body portion and spring blade portion of the pressure plate may each include a top surface 36 and a bottom surface 38 defining a thickness AA of the main body portion 30 and a thickness BB of the spring blade portion 32. The main body portion 24 of the friction pad includes a top surface 40 and a bottom surface 42 that define a thickness CC. The sacrificial portion of the friction pad includes a top surface 40 and a bottom surface 42 that define a thickness DD. In one approach, the thickness DD of the sacrificial portion 26 is greater than the thickness CC of the main body portion 24 so that the top surface of the sacrificial portion 26 engages the rotor prior to the top surface of the main body portion 24.

In another embodiment as shown in FIG. 4, the pressure plate includes a main body portion 30 having a top surface 50 and a bottom surface 52 that are spaced apart to define a thickness EE. The spring blade portion 32 having a top surface 54 and a bottom surface 56 that are spaced apart to define a second thickness FF. The friction pads include a main body portion 24 having a top surface 58 and a bottom surface 60 that are spaced apart to define a thickness GG. A sacrificial portion, including a button portion 66, may be separate from the main body portion 24 of the friction pad as shown in FIG. 4. The button portion 66 has a top surface 62 and a bottom surface 64 that are spaced apart to define a second thickness HH. Preferably, the second thickness FF of the spring blade portion 32 is less than the thickness EE of the main body portion 30 so as to allow the spring blade portion to deform, deflect, bias, or otherwise a pad axis PA, (as shown in FIG. 1). In one aspect, the pressure plate with the top surfaces 50 and 54 of the main body portion 30 and the spring blade portion 32, respectively, are generally co-planar. In another aspect, the friction pad with the second thickness HH of the button portion 66 is greater than the thickness GG of the main body portion 24. Advantageously, when the top surface of the pressure plate and the spring blade are generally co-planar; this allows the top surface 62 of the button portion 66 to engage the rotor prior to the top surface 58 of the main body portion 24. It is appreciated that the thicknesses AA, BB, CC, DD, EE, FF, GG, and HH are taken along the pad axis PA, that is generally parallel to the rotor axis.

For the above, instead of or in addition to varying thicknesses, the spring blade portion 32 may be deformed (e.g., upwardly) so the top surface 54 of the spring blade portion is elevated relative to the top surface 50 of the main body portion.

In a brake-on position, the sacrificial portion will generally be the same height as the top surface of the main body portion of the friction pad. In a brake-off position, the top surface of the sacrificial portion will be elevated relative to the top surface of the main body portion of the friction pad. As such, in a brake-off position, the top surface of the sacrificial portion will be elevated (non-coplanar) with respect to the top surface of the main body portion. As shown in FIG. 2, the main body portion of the brake pad may have a height H1 and the sacrificial portion may have a height H2 that is greater than H1. It is further appreciated that references to thicknesses and heights are determined with respect to the rotor axis RA, which may be generally perpendicular to top and bottom surfaces of the brake pad and generally parallel to the pad axis PA.

The caliper assembly may further include a gap 70 separating the main body portion from the spring blade portion. These gaps may extend from the leading end, the trailing end, or both as shown in FIGS. 3A-3C. For example, as shown in FIG. 3, one or more gaps 70 may be provided, (e.g., generally tangentially positioned with respect to the rotor rotational axis RA). The main body portion and the sacrificial portion of the friction pad may be integrally formed, as in FIG. 2. They may be separate from one another, as in FIG. 4. The friction pad may include a material that is the same or different for the main body portion 24 and the sacrificial portions 26.

Referring to FIG. 5, another embodiment is depicted in which a first sacrificial portion 86 may be carried on a rotor 20 including a hat portion 80 and a disc portion 82. Thus, the disc portion 82 can include a main body portion 84 having a first stiffness and the first sacrificial portion 86 having a second stiffness that is less stiff than the first stiffness of the main body portion 84. The main body portion has a top surface 88 and a bottom surface 90 that are spaced apart and bounded by an outer wall 92 and an inner wall 94. The first sacrificial portion has a top surface 96 and a bottom surface 98 that are spaced apart and bounded by an outer wall 100 and an inner wall 102. The outer wall 100 of the first sacrificial portion is located proximate to the inner wall 94 of the main body portion and may be separated by a gap 104.

The top and the bottom surfaces of the main body portion and the first sacrificial portion are configured to engage the top surfaces of the friction pads of the caliper assembly. The first sacrificial portion may be further configured to axially deflect the top surface, the bottom surface, or both with respect to the top surface, the bottom surface, or both of the main body portion. As such, in the brake-on position, the top surface of the first sacrificial portion engages a first portion of the friction pad prior to the top surface of the main body portion engaging a second portion of the friction pad. The first sacrificial portion may be supported by a plurality of attachment members 106 such as posts, fasteners, or otherwise. It optionally may be spring biased for urging the sacrificial portion to a height higher than the top surface 88 of the main body portion.

As a result of the deflection during the brake-on position and the engagement of the brake pad with the first sacrificial portion of the rotor face, the surfaces deflected under load will stand proud of the main body portion in the unloaded or brake-off position. The magnitude of the deflection and hence the protrusion of the deflected surface of the first sacrificial portion above the main body portion can be designed to ensure that during brakes-off position only the first sacrificial portion contacts the inboard friction pad and hence only the first sacrificial portion of the rotor is subject to DTV.

The annular sacrificial portion of the rotor may be inside the main body portion so that the effective radius of the sacrificial portion, and hence the BTV, are minimized (FIG. 5). As such, it is possible to devise rotor designs that have multiple annular sacrificial portions with reduced stiffness positioned at any suitable radial location, these sacrificial portions may be potentially positioned at an inner location, an outer location, or an intermediate location.

It is contemplated that over time, the sacrificial portion of the friction pad, the rotor, or both will wear at a rate such as to generally maintain a differential height between the sacrificial portion and the main body portion (e.g., top surface of sacrificial portion with respect to the top surface of the main body portion. It is further appreciated that the sacrificial portion may be designed to perform the function of a “brake pad wear indicator” that is typically achieved using an additional stamped part.

As can be appreciated the increased deflection of the sacrificial portion components during braking results in reduced clearance between the friction pad and the rotor components when in a brake-off position. This helps ensure that even as the friction pads and the rotor components wear, the sacrificial portion will be the first to contact the rotor during the brake-off position ensuring that the sacrificial portion alone will be subject to cyclic contact and resulting DTV. Further, because of the role played by the sacrificial portion, it is believed possible to reduce BTV to negligible levels, which help minimize the cause of pulsations detectable by the driver.

In the brake-on position, friction pads, rotor, or each may include several portions that provide the same or different amounts of braking work across the surface of the friction pad that when taken together define a total braking surface width with respect to that specific friction pad or rotor. As such, it is appreciated that the sacrificial portion of the friction pad and/or the rotor contributes on the order of about 3 to about 25%, more specifically about 5 to about 15%, (e.g., about 10%) of the total braking surface width. Furthermore, it is appreciated that the main body portion of the friction pad, the rotor, or both provide about 85 to about 95% of the total braking surface width.

The present invention, also contemplates methods of manufacturing. For example, one method envisions applying a mass of friction pad to a pressure plate and then separating at least a portion of the friction pad, the pressure plate or both, to define a fully or partially separated main body portion having a first stiffness and at least one sacrificial portion having a second stiffness that is less stiff than the first stiffness. It is envisioned also that methods will include a friction pad material removal step that includes removing material from the main body portion of the friction pad to define a thickness or height differential between the friction pad of the main body portion and that of the sacrificial portion. More specifically, removing material (e.g. grinding) from the friction pad may be done by engaging the surface of the friction pad with a material removal tool, during which, because of the deflection of the spring blade portion, the resulting amount of material removed from the friction pad is less than in the main body portion. A height differential thus results between the upper surface of the friction pad in the main body portion and the spring blade portion. The separating step may occur prior to the step of applying the mass of friction pad to the pressure plate or after.

The method also contemplates the possibility of a separate step of attaching (e.g., welding, fastening, bonding, or any combination thereof spring blade portion to the main body portion of the pressure plate.

In one particular respect, the pressure plate herein may be made by a method that includes forming a shaped pressure plate, in which a piece of metal is stamped. The step of making the pressure plate may further comprise a step of coining a portion of the spring blade portion to define a first thickness that is less than the second thickness of the main body portion.

For example, for making a brake pad as shown in FIG. 4, the spring blade portion may be initially stamped as part of the pressure plate blanking, wherein the thickness of the spring blade portion may be initially the same as the main body portion of the pressure plate. The spring blade portion may be coined to decrease its thickness so that it does not contact any piston or finger of the caliper, and to fill at least a portion of the gap (e.g., decrease the width of at least a portion of the gap) between the spring blade portion and the main body portion of the pressure plate both being configured to contain the friction pad during molding. The button portion 66, (as shown in FIG. 4), of the friction pad may be separated (e.g., cut) from the main body portion. The top surface of the main body portion of the friction pad may be then ground.

It is appreciated that the removing step may occur prior to or after applying the friction pad to the pressure plate. For example, one approach includes applying the friction pad material to the pressure plate and then slitting it to separate into portions for each. Preferably, the removing step occurs after the friction pad has been mounted to the pressure plate. During this operation, the spring blade portion, including the sacrificial portion deflects so that after grinding the main body portion of the friction pad, the top surface of the sacrificial portion is higher than the top surface of the main body portion. More specifically, after the removing step, the top surface of the main body portion of the friction pad will have a first thickness that is less than the second thickness of the sacrificial portion. An alternative method of achieving the spring blade function may be to rivet an additional steel stamping to the pressure plate and then mount the friction pad.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

1. A corner module, comprising:
a knuckle;
a hub and bearing;
a caliper assembly including a caliper that carries at least two opposing and spread apart brake pads, each including a friction pad; and
a rotor having a rotational axis including a hat portion and a disc portion, the disc portion disposed between the at least two brake pads,
wherein at least one of the friction pad and the rotor includes a main body portion having a first stiffness and at least one sacrificial portion having a second stiffness that is less stiff than the first stiffness of the main body portion,
wherein, in a brake-off position, a first running clearance between the friction pad and the rotor of the at least one sacrificial portion will be lower than a second running clearance between the friction pad and the rotor of the main body portion, and
wherein, in a brake-on position, the axial deflection of the at least one sacrificial portion exceeds the axial deflection of the main body portion.

2. The corner module of claim 1, wherein for the friction pad including the at least one sacrificial portion, the friction pad is supported on a pressure plate that includes a main body portion and at least one spring blade portion that supports the at least one sacrificial portion.

3. The corner module of claim 2, wherein the main body portion of the pressure plate, the friction pad, or both includes a top surface and a bottom surface that are spaced apart to define a first thickness, and the at least one spring blade portion, the at least one sacrificial portion, or both includes a top surface and a bottom surface that are spaced apart to define a second thickness such that the top surfaces are at a different height relative to one another in the brake-off position.

4. The corner module of claim 3, wherein the second thickness of the at least one sacrificial portion is greater than the first thickness of the main body portion of the friction pad so that the top surface of the at least one sacrificial portion engages the rotor prior to the top surface of the main body portion of the friction pad.

5. The corner module of claim 3, wherein the second thickness of the pressure plate is less than the first thickness of the pressure plate, and wherein in the brake-off position, the top surface of the at least one spring blade portion of the pressures plate is generally co-planar relative to the top surface of the main body portion of the pressure plate.

6. The corner module of claim 1, wherein the first stiffness and the second stiffness are in the direction generally parallel with the rotational axis of the rotor.

7. The corner module of claim 2, wherein the spring blade portion is cantilevered and is joined to the main body portion of the pressure plate via a transition portion about which the spring blade portion deflects when the at least one sacrificial portion engages the rotor.

8. The corner module of claim 7, wherein the main body portion and at least one of the at least one sacrificial portion or the at least one spring blade portion form at least one gap therebetween.

9. The corner module of claim 3, wherein the main body portion of the friction pad and the at least one sacrificial portion of the friction pad are separate from one another.

10. The corner module of claim 1, wherein the ratio of the first stiffness and second stiffness is from about 200,000:1 to about 1,000:1, the at least one sacrificial portion contributes on the order of about 5 to about 15% of the total braking pad surface width, or a combination of both.

11. The corner module of claim 1, wherein the caliper further includes a piston portion and a finger portion spaced apart and generally opposing one another, the piston portion or the finger portion located generally adjacent to the bottom surface of the main body portion of the pressure plate and substantially free of contact with the at least one spring blade portion.

12. The corner module of claim 1, wherein the main body portion and the at least one sacrificial portion are located within the disc portion of the rotor, the main body portion and the at least one sacrificial portion include a top surface and a bottom surface, and an outer surface and an inner surface and wherein at least one of the top surface or the bottom surface of the main body portion, the at least one sacrificial portion, or both is configured to engage at least one of the at least two friction pads.

13. The corner module of claim 12, wherein the main body portion and the sacrificial portion are spaced apart with respect to one another so that the outer surface of one is located proximate to the inner surface of the other and wherein at least one of the top surface or the bottom surface of the sacrificial portion is axially deflected with respect to the top surface or the bottom surface of the main body portion.

14. The corner module of claim 12, wherein the at least one sacrificial portion is supported by a plurality of fastening members and wherein a portion of the axial deflection occurs between at least two of the plurality of fastening members.

15. A brake pad for a vehicle, comprising:
a friction pad including:
a main body portion having a top surface and a first stiffness; and
at least one sacrificial portion having a top surface and a second stiffness that is less stiff than the first stiffness of the main body portion,
wherein in a brake-on position, the deflection of the at least one sacrificial portion will be greater than the deflection of the main body portion upon at least a portion of the brake pad engaging at least a portion of a rotor having a rotor axis, and
wherein in a brake-off position, a first running clearance between the at least one sacrificial portion and the rotor will be lower than a second running clearance between the main body portion and the rotor, and wherein over time, during brake operation, the at least one sacrificial portion will wear at a rate such as to generally maintain a differential height between the top surface of the sacrificial portion and the top surface of the main body portion, and
wherein the main body portion includes a top surface and a bottom surface that are spaced apart to define a first thickness that is generally parallel to the rotor axis and the at least one sacrificial portion includes a top surface and a bottom surface that are spaced apart to define a second thickness that is generally parallel to the rotor axis and is greater than the first thickness.

16. The brake pad assembly of claim 15, wherein for the friction pad including the at least one sacrificial portion, the friction pad is supported on a pressure plate that includes a main body portion having a first thickness and at least one spring blade portion that supports the at least one sacrificial portion, and wherein the spring blade portion of the pressure plate is coined to thin the spring blade portion and thereby define a second thickness for the spring blade portion that is less than the first thickness of the main body portion of the pressure plate so that a bottom surface of the at least one spring blade portion is axially displaced with respect to a bottom surface of the main body portion.

17. The method of manufacturing a brake pad, comprising the steps of:
applying a mass of friction pad material to a pressure plate;
separating at least a portion of the friction pad, the pressure plate, or both, thereby at least partially separating a main body portion having a first stiffness from at least one spring blade portion, at least one sacrificial portion, or both having a second stiffness that is less stiff than the first stiffness.

18. The method of claim 17, further comprising the step of removing material from the main body portion of the friction pad so as to defines a first thickness that is less than the at least one sacrificial portion of the friction pad having a second thickness.

19. The method of claim 18, wherein the step of removing material from the friction pad is achieved by engaging the surface of the friction pad with a material removal tool, during which, because of the deflection of the spring blade portion, the resulting amount of material removed from the at least one sacrificial portion is less than in the main body portion of the friction pad so that a height differential results between the upper surface of the friction pad in the main body portion and the at least one sacrificial portion.

20. The method of claim 17, further comprising the step of coining the spring blade portion to thin the spring blade portion and thereby define a second thickness for the spring blade portion that is less than the first thickness of the main body portion so that the bottom surface of the at least one spring blade portion is axially displaced with respect to the bottom surface of the main body portion and further to reduce a portion of the gap between the main body portion and the at least one spring blade portion.
